(19) United States
(12) Patent Application Publication
(10) Pub. No.: US 2011/0182167 A1
(43) Pub. Date: Jul. 28, 2011

(54) OPTICAL PICKUP DEVICE AND METHOD FOR MANUFACTURING THE SAME

(75) Inventors: Masahito OGATA, Tokyo (JP); Ryoichi Kawasaki, Isesaki-Shi (JP)

(73) Assignees: SANYO Electric Co., Ltd., Moriguchi-shi (JP); SANYO Optec Design Co., Ltd., Tokyo (JP)

(21) Appl. No.: 13/011,568

(22) Filed: Jan. 21, 2011

(30) Foreign Application Priority Data
Jan. 22, 2010 (JP) 2010-011929

(51) Int. Cl. G11B 7/135

(52) U.S. Cl. 369/112.24; G9B/7.121

(57) ABSTRACT

An optical pickup device comprises a first objective lens fixed on a lens holder and configured to focus a first laser beam on a signal recording layer provided in an optical disc, the lens holder supported by support wires so that the lens holder is movable toward a signal surface of an optical disc and in a radial direction of the optical disc, and a second objective lens fixed on the lens holder and configured to focus a second laser beam on a signal recording layer provided in an optical disc. Bearing surfaces of the first and second objective lenses are tilted at predetermined angles, respectively, generation directions of coma aberrations by the first and second objective lenses are broadly divided by a simple method, and the objective lenses are fixed with the directions of the coma aberrations aligned.

### BACKGROUND OF THE INVENTION

1. Field of the Invention

The present invention relates to an optical pickup device performing an operation of reading a signal recorded in an optical disc or of recording a signal to an optical disc, and a method for manufacturing the same.

2. Description of the Related Art

There are widely used optical disc apparatuses capable of performing signal read operation and signal record operation by irradiating a signal recording layer of an optical disc with a laser beam applied from an optical pickup device.

Optical disc apparatus are generally used which use an optical disc called CD (Compact Disc) and DVD (Digital Versatile Disc), while optical disc apparatuses have been recently developed which use an optical disc with improved recording density, i.e., an optical disc of the Blu-ray Disc standard or the HD-DVD (High Density Digital Versatile Disc) standard.

A laser beam used for the operation of reading a signal recorded in the optical disc of the CD standard is infrared light with a wavelength of 780 nm. A laser beam used for the operation of reading a signal recorded in the optical disc of the DVD standard is red light with a wavelength of 650 nm. A protective layer with a thickness of 1.2 mm is provided on a top surface of the signal recording layer of the optical disc of the CD standard, and a numerical aperture of an objective lens for use in the operation of reading a signal from the signal recording layer is specified at 0.45. A protective layer with a thickness of 0.6 mm is provided on a top surface of a signal recording layer of the optical disc of the DVD standard, and a numerical aperture of an objective lens for use in the operation of reading a signal from the signal recording layer is specified at 0.6.

In contrast to the above-described optical discs of the CD standard and the DVD standard, a laser beam used for the operation of reading a signal recorded in the optical disc of the Blu-ray Disc standard or the HD-DVD standard is a laser beam with a shorter wavelength, e.g., blue light with a wavelength of 405 nm.

A protective layer with a thickness of 0.1 mm is provided on a top surface of a signal recording layer of the optical disc of the Blu-ray Disc standard, and a numerical aperture of an objective lens for use in the operation of reading a signal from the signal recording layer is specified at 0.85.

On the other hand, there is provided a protective layer with a thickness of 0.6 mm on a top face of a signal recording layer of the optical disc of the HD-DVD standard, and a numerical aperture of an objective lens for use in the operation of reading a signal from the signal recording layer is specified at 0.65.

As described above, the blue light with a wavelength of 405 nm is usable as the laser beam for the operation of reading signals recorded in the optical discs of the Blu-ray Disc standard and the HD-DVD standard. Thus, an optical pickup device capable of the operation of reading signals from the optical discs of these two standards can be fabricated by use of a laser diode for optical discs of the two standards.

In order to read signals from both the optical discs, however, the numerical aperture needs to be changed corresponding to each of the optical discs since the location of the signal recording layer and the numerical aperture required of the objective lens are significantly different between the two optical discs. There has been developed an optical pickup device capable of performing the above-described operation. This technology is described for instance in Japanese Patent Application Publication No. 2006-172605.

Recently, there has been commercialization of an optical disc apparatus capable of using not only optical discs of the CD standard and DVD standard described above but also optical discs of the Blu-ray Disc standard and the HD-DVD standard. Consequently, an optical pickup device used in such an optical disc apparatus is configured, as a matter of course, to be able to perform the operation of reading signals from the signal recording layers provided in optical discs of all the compatible standards or the operation of recording signals onto the signal recording layer.

Since such an optical pickup device has difficulty in applying the laser beams with the aforementioned wavelengths onto the signal recording layers of optical discs of all the standards by only using a single objective lens, the optical pickup device uses two objective lenses: one for applying the laser beam to the optical discs of the CD standard and the DVD standard, for example; and the other for applying the laser beam to the optical disc of the Blu-ray Disc standard, for example. This technology is described for instance in Japanese Patent Application Publication No. Hei 11-23960.

In the optical pickup device including two objective lenses, for example, an objective lens for an optical disc of the Blu-ray Disc (hereinafter referred to as BD) standard (objective lens for BD) and an objective lens for applying a laser beam onto an optical disc of the CD standard and the DVD standard (objective lens for DVD/CD) are fixed on a lens holder supported by support wires so as to be movable toward signal surfaces of optical discs and in a radial direction of the optical discs, and are configured to perform a focus control operation for focusing the laser beam as a spot onto the signal recording layer provided in the optical disc or to perform a tracking control operation for causing the spot to follow a signal track provided in the signal recording layer through moving operations of the lens holder.

In the optical pickup device thus configured, the wires supporting the lens holder are adjusted in a posture adjustment operation in order to support the objective lens for BD and the objective lens for DVD/CD in optimum states. Such a posture adjustment operation is performed so as to minimize a jitter value included in a signal reproduced from the optical disc, for example. The adjustment operation performed to set the objective lens for BD in the optimum state may result in a situation where the other objective lens for DVD/CD is tilted with respect to the signal recording layer of the optical disc.

There arises a problem that when the posture adjustment operation is performed to optimize only one of the objective lenses, the posture of the other objective lens fails to be optimized, which in turn deteriorates the jitter value. This problem is found to be attributable to coma aberration caused by the tilt of the objective lens.

The coma aberration described above is characterized by increasing with an increase in thickness of a protective layer provided on a top surface of the signal recording layer, by increasing with an increase in a numerical aperture of the objective lens, and by increasing with a decrease in wavelength of the laser beam. Therefore, out of the objective lenses for optical discs of the various standards described above, the objective lens for BD has the largest coma aberration.

For the optical pickup device compatible with the BD standards, backward compatibility is demanded by the market, and BD/DVD/CD compatibility is essential. It is difficult to manufacture a single objective lens compatible with all of the BD/DVD/CD standards, and thus it is the current situation that the two objective lenses for BD and for DVD/CD are mounted on one holder member. In this case, a relative coma aberration of the two objective lenses is further increased, because the object lens for BD has the largest coma aberration and the two objective lenses are different from each other in coma aberration.

For example, in an actuator in which an objective lens having a numerical aperture (hereinafter referred to as NA) of 0.85 (objective lens for BD) and an objective lens having an NA of 0.65 or less (objective lens for DVD/CD) are mounted on one holder member, general amounts of coma generation variation are approximately ±0.05λ for the former lens and ±0.03λ for the latter lens. Accordingly, a relative amount of coma of the two objective lenses is ±0.08λ.

The coma can be corrected by tilting the objective lenses, and coma of, for example, 0.01λ can be corrected by the tilt of approximately 0.1 degree. In this case, if each fixing variation is ±0.2 degree, the maximum tilting degrees for correcting the relative amount of coma are 1.2 degrees. If the two objective lenses are mounted on one holder member and are tilted to correct the coma aberration simultaneously, the optical pickup device cannot function properly any more.

Therefore, in the conventional case, the coma aberrations of the two objective lenses are individually checked, and adjustment in the generation direction of coma aberration and adjustment in tilting the objective lens for cancelling the coma aberration are separately performed.

To be more specific, the coma aberrations of the two objective lenses are corrected by use of an actuator provided with a lens holder having a bearing surface with a curvature where to mount an outer periphery of an objective lens thereon or a lens holder configured to mount a lens in a floating state. In the former holder, one of the lenses (e.g., the objective lens for DVD) is mounted on the bearing face and is fixed with both the angle and direction of coma aberration adjusted. In the latter holder, one of the lenses is attached in the air with an adhesive with both the angle and direction of coma aberration adjusted. Thereafter, in both the holders, the other lens (e.g., the lens for BD) is fixedly attached with the direction of coma aberration adjusted. Then, each of the lens holder having the two lenses mounted thereon is attached to the actuator, and the actuator is tilted to cancel the angle of the coma aberration of the lens for BD.

Furthermore, the above adjustment needs to be performed for each optical pickup device, resulting in a problem that adjustment of coma aberration in the two objective lenses is so cumbersome and complicated that a variation in adjustment and an increase in man-hours occur.

### SUMMARY OF THE INVENTION

This invention provides an optical pickup device including a first objective lens fixed on a lens holder and configured to receive a first laser beam of a first wavelength and to focus the first laser beam on a signal recording layer provided in an optical disc, the lens holder supported by support wires so that the lens holder is movable toward a signal surface of an optical disc and in a radial direction of the optical disc, a second objective lens fixed on the lens holder and configured to receive a second laser beam of a second wavelength different in wavelength from the first laser beam and to focus the second laser beam on a signal recording layer provided in an optical disc, wherein the lens holder is provided with a first bearing surface and a second bearing surface, and at least one of the first and second bearing surfaces is tilted to a main surface of the lens holder, the first objective lens has a first coma aberration, is fixed on the first bearing surface, and is tilted at a first angle to an optical axis of the first laser beam, and the second objective lens has a second coma aberration, is fixed on the second bearing surface so that a direction of the first coma aberration is aligned with a direction of the second coma aberration, and is tilted at a second angle to an optical axis of the second laser beam.

The invention also provides an optical pickup device including a first objective lens configured to receive a first laser beam of a first wavelength and to focus the first laser beam on a signal recording layer provided in an optical disc, the first objective lens being fixed on a lens holder supported by support wires so that the lens holder is movable toward the signal surface of the optical disc and in a radial direction of the optical disc, a second objective lens fixed on the lens holder and configured to receive a second laser beam of a second wavelength different in wavelength from the first laser beam and to focus the second laser beam on a signal recording layer provided in an optical disc, wherein the lens holder has a first bearing surface on which a first objective lens is mounted and a second bearing surface on which a second objective lens is mounted, each of the first and second bearing surfaces has multiple rotational mounting directions set thereon, by equally dividing the bearing surface with lines passing through the center of the bearing surface, the first objective lens is fixed onto the first bearing surface so that a reference point of the first objective lens is positioned in one of the rotational mounting directions, corresponding to a direction of a first coma aberration generated by the first objective lens, and is tilted in the generation direction of the first coma aberration, and the second objective lens is fixed onto the second bearing surface so that a reference point of the second objective lens is positioned in one of the rotational mounting directions, corresponding to a direction of a second coma aberration generated by the second objective lens, and is tilted in the generation direction of the second coma aberration.

The invention also provides a method for manufacturing an optical pickup device including a first objective lens configured to receive a first laser beam of a first wavelength and to focus the first laser beam on a signal recording layer provided in an optical disc, the first objective lens being fixed on a lens holder supported by support wires so that the lens holder is movable toward the signal surface of the optical disc and in a radial direction of the optical disc; and a second objective lens fixed on the lens holder and configured to receive a second laser beam of a second wavelength different in wavelength from the first laser beam and to focus the second laser beam on a signal recording layer provided in an optical disc, the method comprising the steps of preparing one first objective lens extracted from a first resin mold lot and one second objective lens extracted from a second resin mold lot, checking a direction of a first coma aberration generated by the first objective lens, checking a direction of a second coma aberration generated by the second objective lens, determining a first rotational mounting direction corresponding to the generation direction of the first coma aberration from among a plurality of rotational mounting directions previously associated with generation directions of coma aberration, determining a second rotational mounting direction corresponding to the generation direction of the second coma aberration from among the plurality of rotational mounting directions, mounting the first objective lens on the first bearing surface so that a reference point of the first objective lens is positioned in the first rotational mounting direction, and mounting the second objective lens on the second bearing surface so that a reference point of the second objective lens is positioned in the second rotational mounting direction.

### BRIEF DESCRIPTION OF THE DRAWINGS

FIG. 1 is a schematic view showing an optical system of an optical pickup device according to a first embodiment of the invention.

FIG. 2 is a schematic view showing a relationship between an optical disc and the optical system according to the first embodiment of the invention.

FIG. 3 is a plan view showing a lens holder and an actuator according to the first embodiment of the invention.

FIG. 4 is a sectional side view showing a lens holder according to the first embodiment of the invention.

FIG. 5A is a plan view of an objective lens and FIGS. 5B and 5C are plan views of the lens holder according to the first embodiment of the invention.

FIG. 6 is a correspondence table of a coma aberration generation direction and a rotational mounting direction according to the first embodiment of the invention.

FIG. 7 is a schematic view for explaining an amount of coma aberration according to the first embodiment of the invention.

FIGS. 8A and 8B are plan views showing a lens holder according to a second embodiment of the invention.

FIGS. 9A and 9B are cross-sectional views showing a lens holder and objective lenses according to a third embodiment of the invention.

FIG. 10 is a plan view showing a lens holder according to a fourth embodiment of the invention.

FIG. 11 is a plan view showing a lens holder according to a fifth embodiment of the invention.

### DESCRIPTION OF THE INVENTION

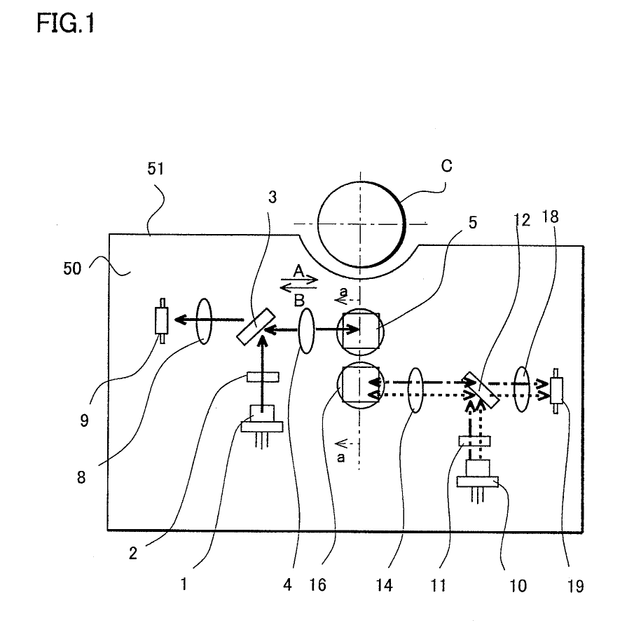

With reference to FIGS. 1 to 11, a preferred embodiment of the invention will be described in detail.

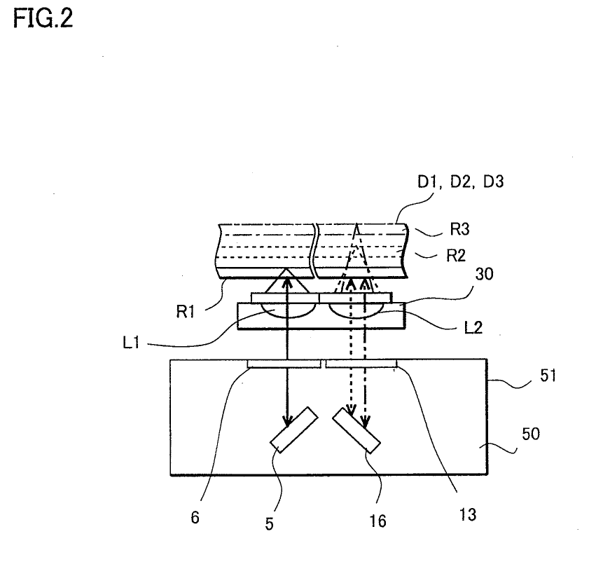

FIG. 1 is a schematic view showing an optical system of an optical pickup device according to this embodiment. FIG. 2 is a schematic view showing a relationship between an optical disc and the optical system. FIGS. 1 and 2 show positional relationships between a signal recording layer R1 provided in a first optical disc D1 and a first objective lens L1, between a signal recording layer R2 provided in a second optical disc D2 and a second objective lens L2, and between a signal recording layer R3 provided in a third optical disc D3 and the second objective lens L2.

In this embodiment, description is given of an optical pickup device compatible with an optical disc of the Blu-ray Disc (hereinafter referred to as BD) standard (the first optical disc), an optical disc of the DVD standard (the second optical disc) and an optical disc of the CD standard (the third optical disc).

In FIG. 1, a laser diode 1 emits a first laser beam (solid line) that is blue light with a first wavelength of, for example, 405 nm. A first diffraction grating 2 receives the first laser beam emitted from the laser diode 1. The first diffraction grating 2 has a diffraction grating portion (not shown) which, splits the first laser beam into 0-order light, +1-order light and −1-order light.

A polarization beam splitter 3 receives the first laser beam transmitted through the first diffraction grating 2. The polarization beam splitter 3 is provided with a control film (not shown) which reflects the first laser beam provided in a S-direction, and transmits the first laser beam polarized in a P-direction.

Here, the first laser beam emitted from the laser diode 1 is set to be S-polarized relative to the control film of the polarization beam splitter 3. As to setting of a linear polarization direction of the first laser beam emitted from the laser diode 1, the linear polarization direction may be changed by rotating the laser diode 1 around an optical axis of the first laser beam or by providing a half-wavelength plate between the laser diode 1 and the polarization beam splitter 3.

A first collimator lens 4 receives the laser beam reflected from the polarization beam splitter 3 and converts the received laser beam into parallel light. Furthermore, the first collimator lens 4 is provided to be movable in directions of arrows A and B by an unillustrated motor for correcting spherical aberration caused by a protective layer of the optical disc (not shown here) of the BD standard.

With reference to FIG. 2, a first reflecting mirror 5 receives and reflects the first laser beam converted into parallel light by the first collimator lens 4.

A first quarter-wavelength plate 6 receives the first laser beam reflected by the first reflecting mirror 5, and converts the received first laser beam from linearly-polarized light into circularly-polarized light.

The first laser beam converted into the circularly-polarized beam by the first quarter-wavelength plate 6 enters the first objective lens L1 provided to focus the laser beam on the signal recording layer R1 provided in the first optical disc D1.

In the above configuration, the first laser beam focused on the signal recording layer R1 of the first optical disc D1 by the first objective lens L1 is reflected as return light from the signal recording layer R1 and then enters the first objective lens L1. In this way, the return light that has entered the first objective lens L1 enters the polarization beam splitter 3 through the first quarter-wavelength plate 6, the first reflecting mirror 5 and the first collimator lens 4.

The return light thus entering the polarization beam splitter 3 is converted from the circularly-polarized light into the light linearly polarized in the P-direction by the first quarter-wavelength plate 6, and is thus transmitted through the control film (not shown) provided in the polarization beam splitter 3. A first sensor lens (anamorphic lens) 8 receives the first laser beam transmitted through the control film provided in the polarization beam splitter 3, and has a cylindrical surface, flat surface, concave surface, convex surface or the like formed on an entrance surface side and an exit surface side.

The first sensor lens 8 described above is provided to generate a focus error signal to be used for a focus control operation by causing astigmatism in the return light. A first photodetector 9 is provided at a position where the return light having passed through the first sensor lens 8 is focused and applied, and is made up of a four-division sensor having photodiodes disposed therein, and the like. The configuration of the first photodetector 9, the operation of generating the focus error signal by the astigmatism method, and the like are well-known, and therefore description thereof is omitted.

As described above, a first optical system is configured to perform an operation of reproducing the signal recorded on the signal recording layer R1 provided in the first optical disc D1 or an operation of recording signals on the signal recording layer R1. Next, description is given of a second optical system configured to perform an operation of reproducing signals recorded on the signal recording layers R2 and R3 provided in the second and third optical discs D2 and D3 or an operation of recording signals on the signal recording layers R2 and R3.

Referring again to FIG. 1, a two-wavelength laser diode 10 is a laser diode which emits laser beams of two different wavelengths, i.e., a second laser beam (broken line) that is red light with a second wavelength of, for example, 650 nm and a third laser beam (dashed line) that is infrared light with a third wavelength of, for example, 780 nm.

A second diffraction grating 11 receives the second laser beam or the third laser beam emitted from the two-wavelength laser diode 10. The second diffraction grating 11 has a diffraction grating portion (not shown) which, splits the received laser beam into 0-order light, +1-order light and −1-order light.

A beam splitter (semitransparent mirror) 12 receives the second laser beam or the third laser beam transmitted through the second diffraction grating 11. The beam splitter 12 is provided with a control film (not shown) which, reflects the second or third laser beam, and transmits the second or third laser beam.

Note that a polarization beam splitter and a half-wavelength plate may be provided in place of the beam splitter 12.

A second collimator lens 14 receives the second or third laser beam and converts the received laser beam into parallel light.

With reference to FIG. 2, a second reflecting mirror 16 receives the second or third laser beam converted into the parallel light by the second collimator lens 14, and reflects the second or third laser beam toward the second objective lens L2 provided to focus the second laser beam (broken line) on the signal recording layer R2 provided in the second optical disc D2 and to focus the third laser beam (dashed line) on the signal recording layer R3 provided in the third optical disc D3.

A second quarter-wavelength plate 13 receives the second or third laser beam reflected by the second reflecting mirror 16, and converts the received second or third laser beam from linearly-polarized light into circularly-polarized light.

In the above configuration, the second or third laser beam focused on the signal recording layer R2 of the second optical disc D2 or the signal recording layer R3 of the third optical disc D3 by the second objective lens L2 is reflected as return light from the signal recording layer R2 or R3 and then enters the second objective lens L2. In this way, the return light that has entered the second objective lens L2 enters the beam splitter 12 through the second quarter-wavelength plate 13, the second reflecting mirror 16 and the second collimator lens 14.

The return light thus entering the beam splitter 12 reflects and transmits the second or third laser beam.

A second sensor lens 18 receives the second laser beam or the third laser beam transmitted through the control film (not shown) provided in the beam splitter 12, and has an effect of generating astigmatism.

The second sensor lens 18 described above is provided to generate a focus error signal to be used for a focus control operation by causing astigmatism in the return light. A second photodetector 19 is provided at a position where the return light having passed through the second sensor lens 18 is focused and applied, and is made up of a four-division sensor having photodiodes disposed therein, and the like. The configuration of the second photodetector 19, the operation of generating the focus error signal by the astigmatism method, and the like are well-known, and therefore description thereof is omitted.

The optical system of the optical pickup device according to the present invention is configured as described above. Next, description is given of an operation of reading signals by the first optical system of the optical pickup device having the above configuration.

With reference to FIG. 1, when the first optical disc D1 is used, a drive current is supplied to the laser diode 1, and the first laser beam of the first wavelength is emitted from the laser diode 1.

The first laser beam emitted from the laser diode 1 enters the first diffraction grating 2 and is split into 0-order light, +1-order light and −1-order light by the diffraction grating portion (not shown) included in the first diffraction grating 2. The first laser beam transmitted through the first diffraction grating 2 enters the polarization beam splitter 3, and is reflected by the control film (not shown) provided in the polarization beam splitter 3.

The first laser beam reflected by the control film enters the first collimator lens 4 and is converted into parallel light by the action of the first collimator lens 4. The first laser beam converted into the parallel light by the first collimator lens 4 enters the first reflecting mirror 5.

Referring to FIG. 2, the first laser beam that has entered the first reflecting mirror 5 is reflected and enters the first objective lens L1 through the first quarter-wavelength plate 6. The first laser beam that has entered the first objective lens L1 is applied as a spot onto the signal recording layer R1 of the first optical disc D1 by the focusing operation of the first objective lens L1. The first laser beam emitted from the laser diode 1 is thus applied as a desired spot onto the signal recording layer R1 of the first optical disc D1, and a numerical aperture of the first objective lens L1 in this case is set to be 0.85.

Moreover, when the first objective lens L1 performs the operation of focusing the first laser beam as described above, spherical aberration occurs due to a difference in thickness of a protective layer provided between the signal recording layer R1 and a signal entrance surface of the first optical disc D1. However, the spherical aberration can be adjusted to be minimized by moving the first collimator lens 4 in the direction of arrow A or arrow B. Such an adjustment operation is generally performed, and therefore description thereof is omitted.

When the application of the first laser beam onto the signal recording layer R1 provided in the first optical disc D1 is performed by the above-described operation, the return light reflected from the signal recording layer R1 enters the first objective lens L1 from the first optical disc D1 side. The return light that has entered the first objective lens L1 enters the polarization beam splitter 3 through the first quarter-wavelength plate 6, the first reflecting mirror 5 and the first collimator lens 4. The return light entering the polarization beam splitter 3 is converted into the light linearly polarized in the P-direction and is thus transmitted through the control film (not shown) provided in the polarization beam splitter 3.

The return light of the first laser beam transmitted through the control film enters the first sensor lens 8, and astigmatism is generated therein by the action of the first sensor lens 8. Then, the return light having the astigmatism generated therein by the first sensor lens 8 is applied onto a sensor portion of the four-division sensor or the like, which is provided in the first photodetector 9, by the focusing operation of the first sensor lens 8. As a result of thus applying the return light onto the first photodetector 9, an operation of generating the focus error signal is performed in a well-known manner by utilizing a change in the shape of the spot of light applied onto the sensor portion included in the first photodetector 9. The focus control operation can be performed by moving the first objective lens L1 toward the signal surface of the first optical disc D1 with use of the focus error signal.

The operation in the case of using the first optical disc D1, i.e., the operation in the case of using the first optical system of the optical pickup device is performed as described above. Next, description is given of an operation in the case of using the second optical disc D2, i.e., an operation in the case of using the second optical system.

Referring again to FIG. 1, when the second optical disc D2 is used, a drive current is supplied to the two-wavelength laser diode 10, and the second laser beam of the second wavelength is emitted from the two-wavelength laser diode 10.

The second laser beam emitted from the two-wavelength laser diode 10 enters the second diffraction grating 11 and is split into 0-order light, +1-order light and −1-order light by the diffraction grating portion (not shown) included in the second diffraction grating 11. The second laser beam transmitted through the second diffraction grating 11 enters the beam splitter 12, and is reflected by the control film (not shown) provided in the beam splitter 12.

The second laser beam reflected by the control film enters the second collimator lens 14 and is converted into parallel light by the action of the second collimator lens 14. The second laser beam converted into the parallel light by the second collimator lens 14 enters the second reflecting mirror 16.

Referring to FIG. 2, the second laser beam that has entered the second reflecting mirror 16 enters the second objective lens L2 through the second quarter-wavelength plate 13. The second laser beam that has entered the second objective lens L2 is applied as a spot onto the signal recording layer R2 of the second optical disc D2 by the focusing operation of the second objective lens L2. The second laser beam emitted from the two-wavelength laser diode 10 is thus applied as a desired spot onto the signal recording layer R2 of the second optical disc D2, and a numerical aperture of the second objective lens L2 in this case is 0.6.

When the application of the second laser beam onto the signal recording layer R2 provided in the second optical disc D2 is performed by the above-described operation, the return light reflected from the signal recording layer R2 enters the second objective lens L2 from the second optical disc D2 side. The return light that has entered the second objective lens L2 enters the beam splitter 12 through the second quarter-wavelength plate 13, the second reflecting mirror 16 and the second collimator lens 14. The return light entering the beam splitter 12 is transmitted through the control film (not shown) provided in the beam splitter 12.

The return light of the second laser beam transmitted through the control film enters the second sensor lens 18, and astigmatism is generated therein by the action of the second sensor lens 18. Then, the return light having the astigmatism generated therein by the second sensor lens 18 is applied onto a sensor portion of the four-division sensor or the like, which is provided in the second photodetector 19, by the focusing operation of the second sensor lens 18. As a result of thus applying the return light onto the second photodetector 19, an operation of generating the focus error signal is performed in a well-known manner by utilizing a change in the shape of the spot of light applied onto the sensor portion included in second photodetector 19. The focus control operation can be performed by moving the second objective lens L2 toward the signal surface of the second optical disc D2 with use of the focus error signal.

The operation of the second optical disc D2 using the second optical system is performed as described above. Next, description is given of an operation of the third optical disc D3 using the second optical system.

Referring to FIG. 1, when the third optical disc D3 is used, a drive current is supplied to the two-wavelength laser diode 10, and the third laser beam of the third wavelength is emitted from the two-wavelength laser diode 10.

In such a state, the third laser beam emitted from the two-wavelength laser diode 10 is applied onto the signal recording layer R3 of the third optical disc D3 through the same optical path as that of the second laser beam described above, and the return light reflected from the signal recording layer R3 is applied onto the second photodetector 19 through the same optical path. Accordingly, the same operation as the focus control operation for the second optical disc D2 is performed for the third optical disc D3.

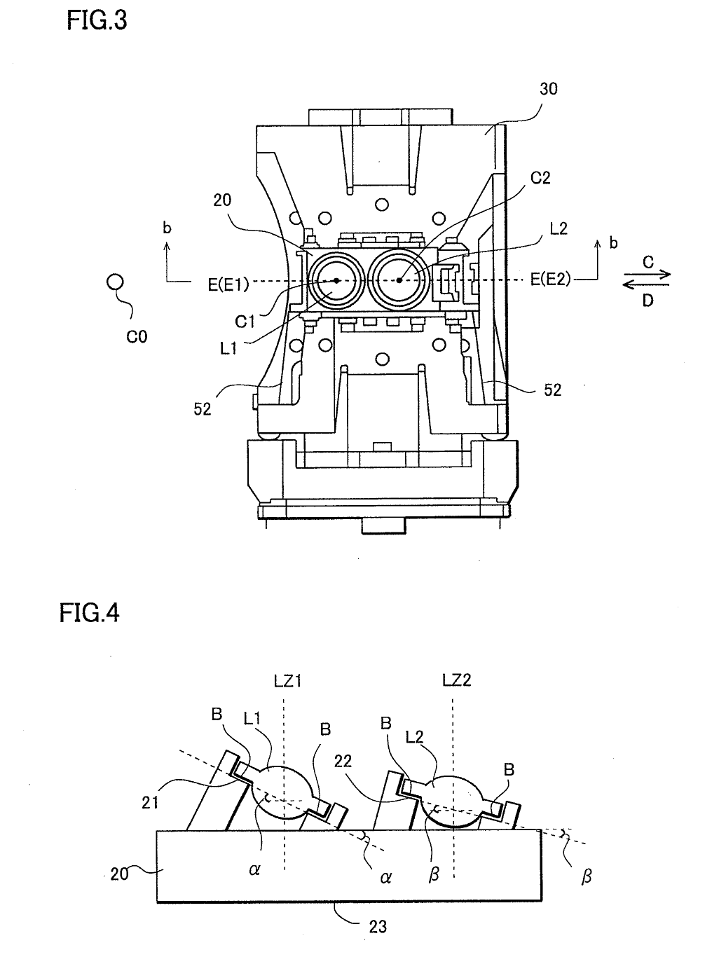

With reference to FIGS. 3 to 11, description is given of the first objective lens L1, the second objective lens L2, and a lens holder 20.

With reference to FIGS. 3 to 7, a first embodiment is described.

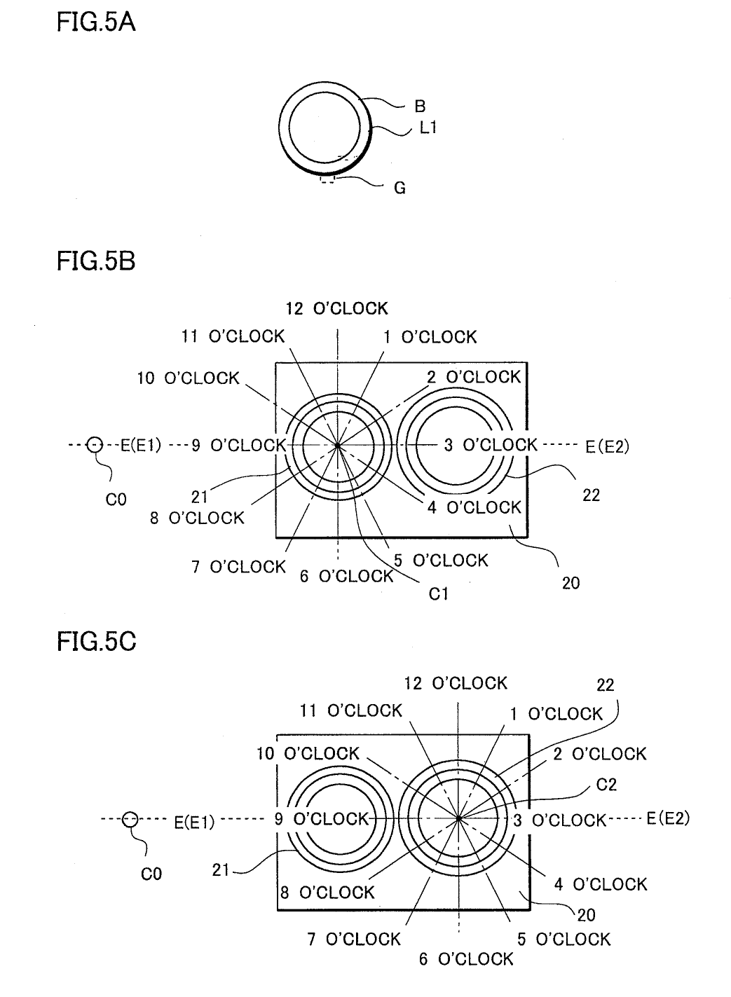

FIGS. 3 and 4 are views showing a relationship between the first objective lens L1 and the second objective lens L2. FIG. 3 is a plan view from above showing the lens holder 20 and an actuator 30 supporting the lens holder 20. FIG. 4 is a sectional side view of the lens holder 20, corresponding to a cross section taken along the line b-b in FIG. 3.

In this embodiment, the lens holder 20 is used, having a structure in which the first objective lens L1 and the second objective lens L2 are mounted at proper angles to a main surface (top surface or bottom surface) of the lens holder 20. Then, rotation directions of the first objective lens L1 and the second objective lens L2 are determined by a simple method so that coma aberration generation directions of both the objective lenses coincide with each other in mounting thereof, thereby uniquely setting an aberration correction direction and polarity (level of inclination (+ or −). Accordingly, an appropriate amount of coma aberration is corrected by the inclination of mounting portions (a first bearing surface and a second bearing surface) of the first objective lens L1 and the second objective lens L2.

The lens holder 20 is supported on a main body (not shown) of the optical pickup device by four support wires 52, for example, so as to be movable toward the signal surface of the optical disc and in a radial direction of the optical disc. Here, the radial direction of the optical disc means a direction of arrows C and D in FIG. 3, i.e., an extending direction of a radial line below the actuator 30 disposed above the optical disc, the radial line connecting the center C0 of the optical disc to the circumference thereof, based on the actuator 30. Moreover, a direction parallel to the surface of the optical disc and at right angles to the radial direction (direction of arrows C and D) is a tangential direction.

The first objective lens L1 and the second objective lens L2 are fixed on one lens holder 20. The lens holder 20 has a first reference line E1 along the radial direction passing through the center C1 of a first bearing surface 21 and a second reference line E2 along the radial direction passing through the center C2 of a second bearing surface 22. In this embodiment, the first and second reference lines E1 and E2 are on the same line, and thus are hereinafter referred to as the reference line E. Furthermore, in this embodiment, as an example, the reference line E coincides with the radial direction of the optical disc, i.e., is on a straight line radially extending from the center C0 of the optical disc.

The first and second objective lenses L1 and L2 have their centers located on the reference line E. Here, a configuration is adopted in which the center C0 of the optical disc is positioned on the reference line E, and the actuator 30 is moved in the radial direction of the optical disc along the extending direction of the reference line E.

With reference to FIG. 4, the lens holder 20 has the first bearing surface 21 and the second bearing surface 22. Here, the first bearing surface 21 means a portion with which a peripheral (flat) portion (flange portion) B of the first objective lens L1 comes into contact. Likewise, the second bearing surface 22 means a portion with which a peripheral (flat) portion (flange portion) B of the second objective lens L2 comes into contact.

The first bearing surface 21 is disposed so as to be inclined at a predetermined angle to an optical axis LZ1 of the first laser beam. To be more specific, in the cross section taken along the reference line E as shown in FIG. 4, for example, the first bearing surface 21 is inclined at a first angle α to a plane perpendicular to the optical axis LZ1 of the first laser beam so that, for example, the center C0 (inner circumference) side of the optical disc is at the highest and the outer circumference side thereof is at the lowest. Meanwhile, the second bearing surface 22 is disposed so as to be inclined at a predetermined angle to an optical axis LZ2 of the second laser beam. To be more specific, in the cross section taken along the reference line E, for example, the second bearing surface 22 is inclined at a second angle β to a plane perpendicular to the optical axis LZ2 of the second laser beam so that, for example, the center C0 (inner circumference) side of the optical disc is at the highest and the outer circumference side thereof is at the lowest.

In other words, in this embodiment, the first and second bearing surfaces 21 and 22 are inclined at predetermined angles to the main surface (e.g., the bottom surface) 23 of the lens holder 20. The main surface 23 of the lens holder 20 is horizontal to the main body of the optical pickup device (outline 51 (see FIG. 1)).

The first angle α is one-half of a correction angle (approximately 0.5 degrees) corresponding to a maximum amount of coma aberration generated (e.g., ±0.05λ) in the first objective lens L1, and is, for example, 0.25 degrees from the plane perpendicular to the optical axis LZ1 of the first laser beam.

The second angle β is one-half of a correction angle (approximately 0.3 degrees) corresponding to a maximum amount of coma aberration generated (e.g., ±0.03λ) in the second objective lens L2, and is, for example, 0.15 degrees from the plane perpendicular to the optical axis LZ2 of the second laser beam. Thus, the maximum relative amount of coma in the first and second objective lenses L1 and L2 can be reduced, thereby making it possible to correct forming variations in coma and to obtain the same effect as significant reduction in the amount of coma generated by the objective lenses.

The first objective lens L1 has a first coma aberration, and the second objective lens L2 has a second coma aberration. The first objective lens L1 is fixed to the first bearing surface 21 so that a generation direction of the first coma aberration is aligned with the reference line E, i.e., the generation direction of the coma aberration is aligned with the direction in which the first bearing surface 21 is inclined (inclination direction). Meanwhile, the second objective lens L2 is fixed to the second bearing surface 22 so that a generation direction of the second coma aberration is aligned with the reference line E, i.e., the generation direction of the coma aberration is aligned with the direction in which the second bearing surface 22 is inclined (inclination direction). Thus, the first objective lens L1 and the second objective lens L2 are fixed on the lens holder 20 so that the generation directions of coma aberration by the first objective lens L1 and the second objective lens L2 are aligned with the radial direction of the optical disc. This is described in detail with reference to schematic plan views shown in FIGS. 5A to 5C. FIG. 5A is a schematic plan view of the first objective lens L1 (the same for the second objective lens L2), and FIGS. 5B and 5C are schematic plan views of the lens holder 20.

The first and second objective lenses L1 and L2 of this embodiment are both objective lenses made of resin, and have a characteristic that the amount and direction of coma aberration are approximate for each resin mold lot since they are formed by injecting resin from gates G with the same resin mold. In other words, a shift in the generation direction of the coma aberration tends to be small with the same resin mold lot.

For each resin mold lot, the generation direction of the coma aberration within a range of 360 degrees is broadly divided into multiple directions. To be more specific, as shown in FIG. 5B, twelve rotational mounting directions are set on the first bearing surface 21 of the lens holder 20 by equally dividing the range into twelve sections with lines including the reference line E (the first reference line E1) and passing through the center C1 of the first bearing surface 21.

Similarly, as shown in FIG. 5C, twelve rotational mounting directions are set on the second bearing surface 22 by equally dividing the range into twelve sections with lines including the reference line E (the second reference line E2) and passing through the center C2 of the second bearing surface 22.

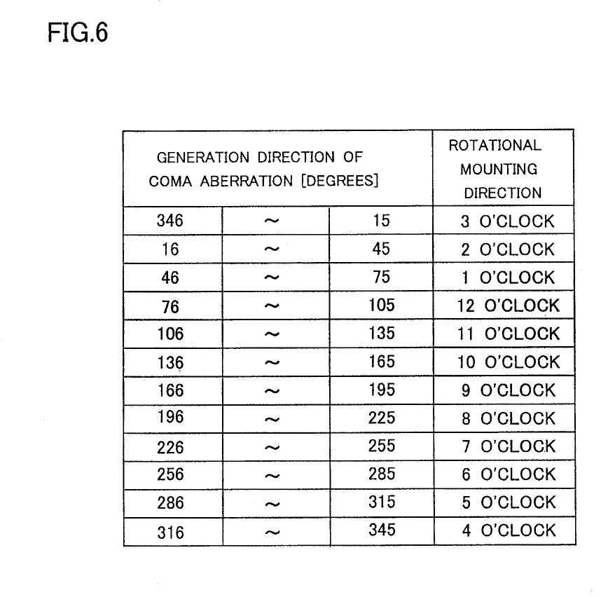

FIG. 6 shows an example of a correspondence table between the twelve equally-divided rotational mounting directions and the actual generation directions [degrees] of coma aberrations by the first and second objective lenses L1 and L2. Here, the rotational mounting directions are represented as 1 o'clock to 12 o'clock directions. In this embodiment, 9 o'clock and 3 o'clock directions correspond to the reference line E (the first and second reference lines E1 and E2), which are directions along the radial direction (here, corresponding to the radial direction). The 9 o'clock direction is the center of the optical disc, and the 3 o'clock direction is the outer circumferential direction of the optical disc (see FIGS. 5B and 5C). By allowing the reference line E to correspond to the radial direction, the generation directions of coma aberration can be aligned with the radial direction.

Furthermore, in this embodiment, the generation direction of the first coma aberration by the first objective lens L1 is recognized by the angle from a reference point of the first objective lens L1. While the position of the gate G provided to form the objective lens is used, for example, as the reference point in this embodiment (see FIG. 5A), the reference point is not limited thereto but there may be provided an alternative identification mark to serve as a reference for recognizing the generation direction of the coma aberration. Meanwhile, the generation direction of the second coma aberration by the second objective lens L2 is also recognized by the angle from a reference point of the second objective lens (e.g., the position of the gate G).

In short, the generation direction of the coma aberration shown in FIG. 6 indicates in what direction and angle the first coma aberration of the first objective lens L1 is generated from the reference point (gate G), while the rotational mounting direction means the direction in which the gate G is disposed when the objective lens is mounted on the first bearing surface 21 (the same goes for the second objective lens L2).

The generation direction of the coma aberration is associated with each of the rotational mounting directions shown in FIG. 6 for each resin mold lot, and the direction of mounting the objective lens is changed by rotating the gate G in the rotational mounting direction corresponding to the generation direction of the coma aberration, thereby enabling alignment of the generation directions of the coma aberrations. As a result, the direction and polarity (level of inclination (+ or −) to be adjusted can be uniquely set to any one of the twelve divided directions (e.g., 3 o'clock direction).

Here, in this embodiment, the state where the generation direction of the first coma aberration and the generation direction of the second coma aberration are “aligned” with each other does not mean only a state where both the directions completely coincide with each other. The coma aberration actually differs from one objective lens to another within the range of 360 degrees. In this embodiment, as shown in FIG. 6, the coma aberration generated within the range of 360 degrees is broadly divided into twelve directions by 30 degrees as an example, thereby simplifying the adjustment of the coma aberration. Therefore, even if, for example, to align the generation directions of the coma aberrations of the first objective lens L1 and the second objective lens L2 in the 3 o'clock direction, the position of the gate G of the first objective lens L1 is set in the 5 o'clock direction and the position of the gate G of the second objective lens L2 is set in the 12 o'clock direction, the directions of the actual coma aberrations of both the objective lenses do not necessarily completely coincide with each other in the 3 o'clock direction (on the reference line E).

However, if the generation direction of the coma aberration falls within the range of 30 degrees (±15 degrees) around the 3 o'clock direction, it does not generally cause any problem in terms of practical performance. For example, when the coma aberration is broadly divided into twelve directions, an angular shift in the actual generation direction of coma aberration relative to one of the directions (e.g., 3 o'clock direction) is ±15 degrees. When a maximum amount of coma aberration generated by the first objective lens L1 (objective lens for BD) is ±0.025λ, a variation in the amount of coma aberration generated by the radial direction due to the angular shift is 0.024λ (=0.025×cos 15 [deg]), and a variation in the amount of coma aberration generated by the tangential direction due to the angular shift is 0.006λ (=0.025×sin 15 [deg]). This shows that the variation in coma aberration due to the angular shift is small and such a variation is practically negligible.

As described above, the state where the generation directions of the coma aberrations are “aligned” in this embodiment means a state where adjustment is made so that the generation direction of the coma aberration is within the range of one of the angles obtained by equally dividing a circle (e.g., within the range of +15 degrees around the 3 o'clock direction) to reduce the variation in coma aberration due to the angular shift to a practically negligible level.

The coma aberration generated by the direction perpendicular to the radial direction of the optical disc, i.e., in the 12 o'clock and 6 o'clock directions (tangential direction) in FIG. 5 results in significant deterioration in reproduction performance. Since the coma aberration is a skew shift, it is preferable that the generation directions of coma aberrations are aligned in the direction with a larger skew margin and thus that the directions are aligned in the radial direction.

When the actuator 30 on which the lens holder 20 is mounted has a tilt adjust mechanism, it is more preferable that an adjustment direction of the actuator 30 is aligned with the generation directions of the coma aberrations by the first and second objective lenses L1 and L2. Also in this regard, it is preferable that the directions are aligned in the radial direction.

The number of rotational mounting directions is not limited to 12, but the first and second bearing surfaces 21 and 22 may be split into 4, 6, 8, 10 or 15 divisions, for example, according to the amount of coma aberrations generated or a variation distribution by the lenses to be used. For example, the rotational mounting direction is broadly divided into 10 directions by 36 degrees in the case of 10-division, and is broadly divided into 15 directions by 24 degrees in the case of 15-division.

When the number of divisions is less than 12, the range of the coma aberration directions corresponding to one rotational mounting direction is increased, resulting in an increase in variation. On the other hand, when the number of divisions is more than 12, association between the coma aberration direction and the rotational mounting direction or mounting of the objective lenses becomes more cumbersome and complicated.

Meanwhile, reduction in the amount of or variation in coma aberrations generated by the objective lenses makes it possible to reduce the number of divisions to be smaller than 12. Even if the amount of or variation in coma aberrations generated is very large, the number of divisions can be increased for use if the price is low.

The upper limit of the number of divisions is preferably about 15, considering that variation from operator to operator tends to be increased. Meanwhile, as the lower limit, 4-division, for example, may be adopted depending on the accuracy of formation of the objective lenses, to the extent that the variation in coma aberration due to the angular shift for the maximum amount of coma aberrations generated by the objective lens for BD described above results in no practical problem.

In this embodiment, 12-division is adopted as an example, in which the variation in coma aberration due to the angular shift is small and practically negligible when the maximum amount of coma aberrations generated by the objective lens for BD is ±0.025λ as described above.

While the same number of rotational mounting directions (number of divisions) is adopted for both of the first and second bearing surfaces 21 and 22 in this embodiment, the rotational mounting directions may be obtained by splitting the respective bearing surfaces by different numbers of divisions. For example, the number of rotational mounting directions on the first bearing surface 21 on which the objective lens for BD (the first objective lens L1) is mounted is 12 (12-division), and the number of rotational mounting directions on the second bearing surface 22 on which the objective lens for CD/DVD (the second objective lens L2) is mounted is 4 (4-division).

In this case, the correspondence table between the generation directions of coma aberrations and the rotational mounting directions shown in FIG. 6 is required individually for the first bearing surface 21 and the second bearing surface 22.

When the objective lenses are made of resin, the directions and amounts of coma aberrations are generally approximate between the resin mold lots. Thus, by determining the rotational mounting direction for each of the first objective lens L1 and the second objective lens L2 for each resin mold lot, the objective lenses of the same resin mold lot can be mounted in the same rotational mounting direction.

There has heretofore been a problem of a variation in assembly or increased man-hours, since even objective lenses of the same resin mold lot are mounted on the lens holder 20 by individually rotating the first objective lens L1 and the second objective lens L2 according to the generation direction of coma aberration. In this embodiment, however, the generation directions of the coma aberrations by the first and second objective lenses L1 and L2 can be aligned with each other by a simple method, thereby achieving significant reduction in variation in assembly or in man-hours. As the variation in assembly, for example, there have been many adjustment errors, adjustment variations from operator to operator, and the like in the conventional case where coma aberration measurement and rotation adjustment are performed. In this embodiment, however, rotational mounting in any of the 12 divisions enables reduction in adjustment errors, adjustment variations from operator to operator, and the like.

In addition, the first bearing surface 21 is provided so as to be inclined at the first angle a for correcting (cancelling) the angle (0.25 degrees) corresponding to one-half of the maximum amount of coma aberration (±0.05λ) expected in the first objective lens L1. Meanwhile, the second bearing surface 22 is provided so as to be inclined at the second angle β for correcting (cancelling) the angle (0.15 degrees) corresponding to one-half of the maximum amount of coma aberration (±0.03λ) expected in the second objective lens L2.

In this way, not only can the relative amount of coma aberration generated by the first and second objective lenses L1 and L2 be reduced but also cumbersome angle adjustment for correcting the amount of coma aberration is no longer required without performing individual angle adjustments, if both the objective lenses are of the same resin mold lot, just by mounting the objective lenses on the first and second bearing surfaces 21 and 22, respectively.

There have heretofore been required operations of, for example: mounting the first objective lens L1 on the lens holder and fixing the lens after performing angle adjustment of the first objective lens L1 using an autocollimator; mounting the second objective lens L2 on the lens holder and fixing the lens after performing angle adjustment of the second objective lens L2 using the autocollimator; and adjusting a relative shift in tilt between the first and second objective lenses L1 and L2 using the autocollimator.

In this embodiment, on the other hand, the first and second bearing surfaces 21 and 22 of the lens holder 20 are provided so as to be inclined at predetermined angles, respectively, to reduce by half the maximum relative amount of coma. Accordingly, individual angle adjustment of the lenses and individual adjustment of relative shift in tilt by use of the autocollimator are no longer required (except for adjustment at the start of daily production, for example), thereby enabling simplification and significant reduction in man-hours.

Note that, in this embodiment, the relative amount of coma generated by the first and second objective lenses L1 and L2 cannot always be reduced to absolutely 0, but performance acceptable for the optical pickup device can be ensured.

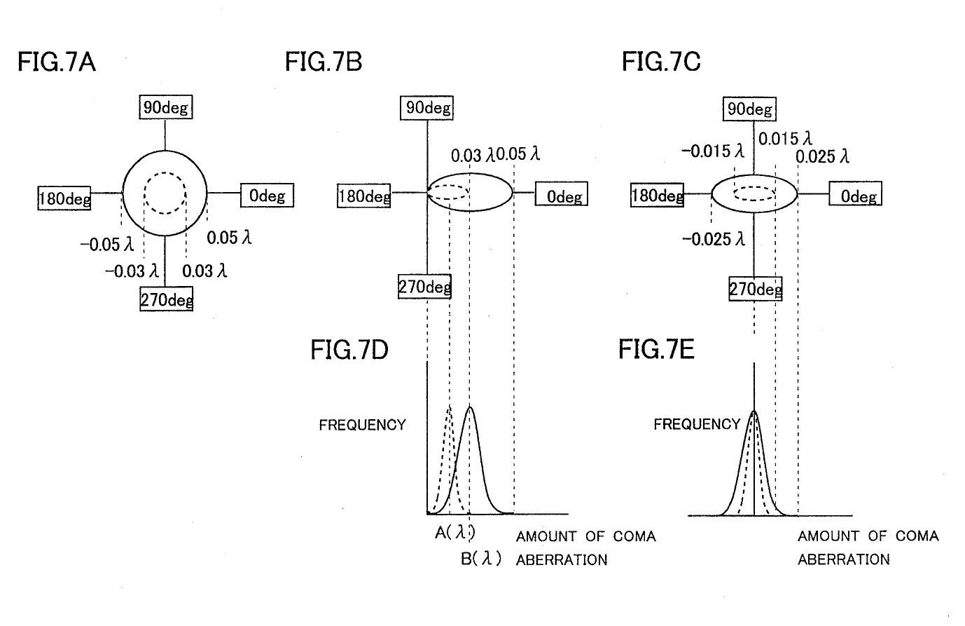

FIGS. 7A to 7C are schematic views for explaining angles and amounts of coma aberrations in all the resin mold lots of the first and second objective lenses L1 and L2. FIG. 7A shows the case where the coma aberration is not adjusted, FIG. 7B shows the case where only rotation adjustment is performed in accordance with the rotational mounting directions of this embodiment, and FIG. 7C shows the case where the lenses are mounted on the lens holder 20 that is inclined, after rotation adjustment is performed in accordance with the rotational mounting directions of this embodiment. FIGS. 7D and 7E are schematic views showing a relationship between the amount of coma aberration and frequency of occurrence thereof.

In all the above cases, the solid line represents the first objective lens L1 (objective lens for BD), and the broken line represents the second objective lens L2 (objective lens for DVD).

In FIGS. 7A to 7C, coordinate axes indicate angles of generation directions of coma aberrations, and circles (ellipses) indicate the amounts of coma aberrations.

As shown in FIG. 7A, when the coma aberration is not adjusted, the coma aberration is generated by every direction, i.e., 360 degrees, the amount of coma aberration around the origin (mechanical reference position) is ±0.05λ in the first objective lens L1 and ±0.03λ in the second objective lens L2, and the relative amount of coma results in a circle of ±0.08λ.

As shown in FIG. 7B, the generation directions of coma aberration are aligned in the radial direction of the optical disc after the rotation adjustment, the coma aberration in the radial direction can be regarded as almost zero, and the coma aberration in the radial direction is also reduced by half. However, a shift amount from the origin is still 0.05λ.

In FIG. 7C, angle correction for A (λ) that is the angle corresponding to one-half of the maximum amount of coma aberration is performed for the second objective lens L2, and angle correction for B (λ) that is the angle corresponding to one-half of the maximum amount of coma aberration is performed for the first objective lens L1. Specifically, by shifting the lenses to the mechanical reference position so that the frequency of occurrence of coma aberrations coincide with each other (see FIG. 7E), the amount of coma aberration turns out to be ±0.025λ in the first objective lens L1 and ±0.015λ in the second objective lens L2, and the relative amount of coma turns out to be an ellipse of ±0.04λ at the long axis around the mechanical reference position as shown in FIG. 7C. This shows that, compared with the case of FIG. 7B, the generation directions of coma aberrations are aligned in the radial direction of the optical disc, the relative amount of coma aberrations generated is fully reduced from 0.08λ to 0.04λ, and the shift amount from the origin is also fully reduced by half from 0.05λ to 0.025λ, meaning that there is less variation in coma aberration.

Here, an allowable amount of coma aberration for an optical disc apparatus is considered to be about 0.07λ or less as a definition of aberration (Marechal criterion) as the limit at which the spot on the optical disc can be narrowed down to the diffraction limit. For this reason, in the optical pickup device, it is preferable that the aberration is suppressed to about 0.04λ considering a margin of the optical disc and the like.

According to this embodiment, the amount of coma aberration in each of the first and second objective lenses L1 and L2 can be set within ±0.04λ, and the performance acceptable for the optical pickup device based on the Marechal criterion can be ensured. Furthermore, even when the optical pickup device is placed in a tilted position on a drive device so as to maximize the performance of the first objective lens L1, the relative amount of coma aberration generated can be reduced to ±0.04λ. As a result, the coma aberration in the first objective lens L1 turns out to be 0λ and the coma aberration in the second objective lens L2 turns out to be 0.04λ, thereby making it possible to ensure the performance acceptable for the optical pickup device based on the Marechal criterion.

For rotating the first objective lens L1 and the second objective lens L2, a method can be adopted, as an example, in which an image of the first and second objective lenses L1 and L2 mounted on the lens holder 20 is taken with a CCD (Charge Coupled Devices) camera, and gates are rotated by recognizing twelve rotational mounting directions, for example, with identification marks on a monitor.

However, the method is not limited thereto, but the identification marks of the twelve rotational mounting directions may be provided as grooves or the like in the peripheries of the first and second bearing surfaces 21 and 22.

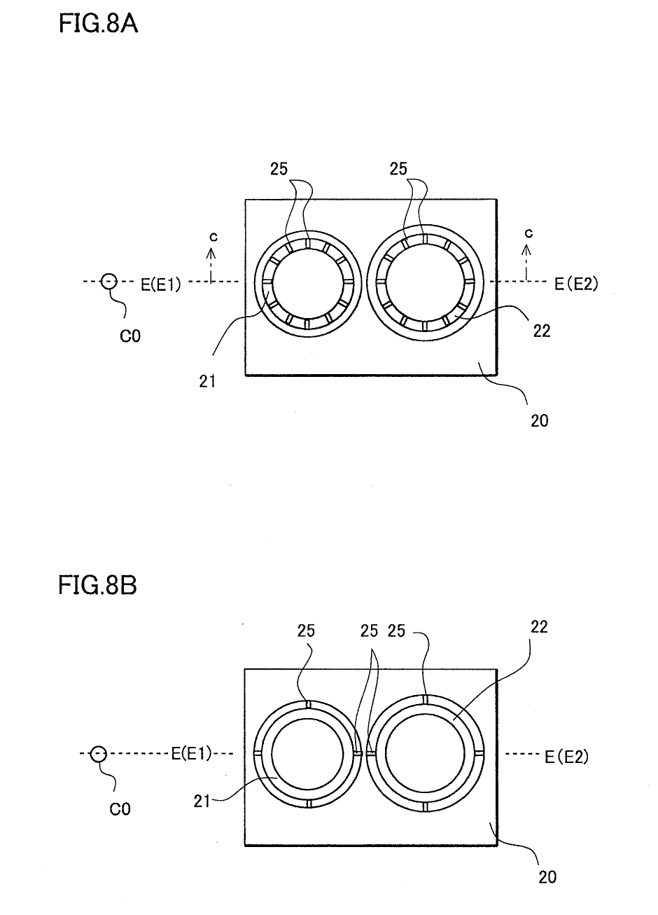

With reference to FIGS. 8A and 8B, a second embodiment of the invention is described. FIGS. 8A and 8B are plan views showing a lens holder 20 according to a second embodiment. The lens holder 20 has multiple identification marks 25 corresponding to rotational mounting directions on a first bearing surface 21 and a second bearing surface 22 (FIG. 8A) or around the first and second bearing surfaces 21 and 22 (FIG. 8B), for example.

The identification marks 25 are, for example, concave or convex portions each having a difference in level from its surrounding, such as notches, grooves, protrusions or the like, and are provided in plural numbers corresponding to the rotational mounting directions. For example, FIG. 8A shows the case where twelve identification marks 25 are provided, while FIG. 8B shows the case where four identification marks 25 are provided.

The identification marks 25 may also serve as, for example, spacers for preventing contact with the objective lenses, convex portions for preventing an adhesive from flowing out, or the like.

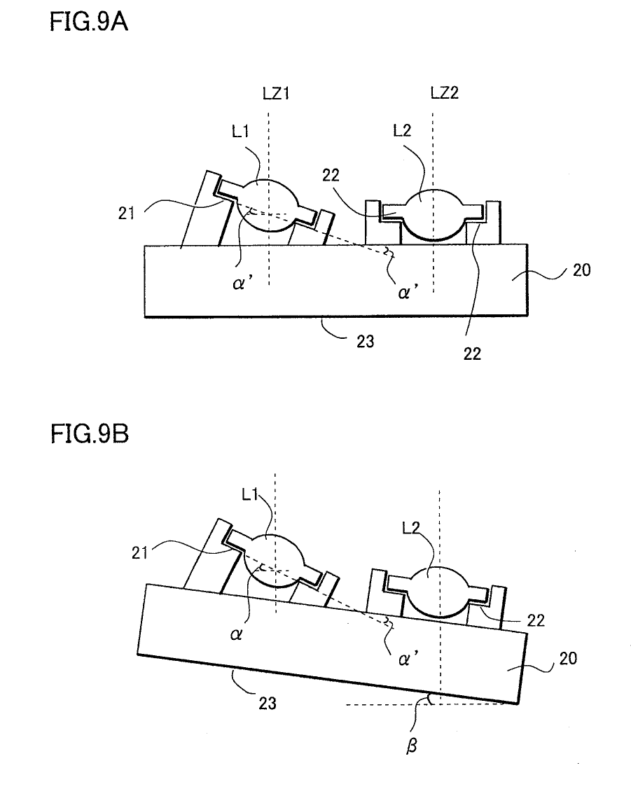

With reference to FIGS. 9A and 9B, a third embodiment of the invention is described. In this embodiment, a configuration may be adopted in which at least one of the first and second bearing surfaces 21 and 22 is provided so as to be tilted to the main surface of the lens holder 20, a first objective lens L1 is fixed while being tilted at a first angle to an optical axis LZ1 of a first laser beam, and a second objective lens L2 is fixed while being tilted at a second angle to an optical axis LZ2 of a second laser beam.

As shown in FIGS. 9A and 9B, in the third embodiment, a configuration may be adopted in which a second bearing surface 22 for fixing a second objective lens L2 is provided horizontal to a main surface (bottom surface) 23 of a lens holder 20 (FIG. 9A), and the second bearing surface 22 is tilted at a second angle 13 from a direction perpendicular to an optical axis LZ2 of a second laser beam by tilting the lens holder 20. The tilt direction is an extending direction of a reference line E (e.g., 3 o'clock and 9 o'clock), i.e., a direction in which the bearing surfaces are tilted at the angles α and β so that, for example, the inner circumference side is at the highest and the outer circumference side is at the lowest in the cross section taken along the reference line E.

In this case, the lens holder 20 may be tilted at the second angle β to a frame of an actuator 30 horizontal to the surface of a housing of the optical pickup device (not shown), or the lens holder 20 may be mounted horizontal to the actuator 30 and the actuator 30 may be tilted at the second angle β to the surface of the housing of the optical pickup device.

In the third embodiment, a first bearing surface 21 on which a first objective lens L1 is fixed is also tilted as the lens holder 20 is tilted. Thus, an angle α′ at which the first bearing surface 21 is tilted is set to be an angle obtained by subtracting the second angle β from the tilt angle (first angle α) of the first bearing surface in the first embodiment.

Note that the third embodiment requires an operation of checking the angle (second angle β) with an autocollimator after mounting of the first and second objective lenses L1 and L2, for tilting the lens holder 20 (or the actuator 30).

Even in this case, however, the mounting angle of the first objective lens L1 and physical positions of both the objective lenses are fixed. Accordingly, it is only necessary to check if any one of the objective lenses is tilted at the second angle β. As a result, operation processes can be significantly simplified as compared with the conventional case where three check operations using the autocollimator are required.

As described above, the lens holder 20 is supported on the main body of the optical pickup device by the support wires 52 so as to be movable toward the signal surface of the optical disc and in the radial direction of the optical disc. A focus coil and a tracking coil for performing such an operation are provided to the lens holder 20. This configuration is well-known and therefore description thereof is omitted.

Hereinafter, description is given of an example of a method for mounting a first objective lens L1 and a second objective lens L2 on a lens holder 20, as a method for manufacturing an optical pickup device of this embodiment. The lens holder 20 is, for example, the lens holder 20 of the first embodiment shown in FIG. 4.

First Step: First, a first objective lens L1 extracted from a first resin mold lot and a second objective lens L2 extracted from a second resin mold lot are prepared.

As described above, the first and second objective lenses L1 and L2 of the embodiment are lenses made of resin. The resin-made lenses are generally formed by injecting melted resin into a hollow portion of a mold from a gate and then cutting off the resin from the gate portion after the resin is solidified. Accordingly, generation directions of coma aberrations relative to the reference point (e.g., gate position) of the objective lens and amounts of coma aberrations are approximate between the objective lenses of the same resin mold lot.

Specifically, in order to check the generation direction of coma aberration for each resin mold lot, one first objective lens L1 is extracted from the first resin mold lot and one second objective lens L2 is extracted from the second resin mold lot.

Second Step: For the first objective lens extracted from the first resin mold lot, a generation direction of a first coma aberration therein is checked. The generation direction of coma aberration is checked for each resin mold lot with a shipping inspection table attached by a manufacturer, for example. The generation direction of the coma aberration (first coma aberration) by the first objective lens L1 is, for example, 300 degrees.

Third Step: Similarly, for the second objective lens extracted from the second resin mold lot, a generation direction of a second coma aberration therein is checked. The generation direction of the coma aberration (second coma aberration) by the second objective lens L2 is, for example, 100 degrees.

Fourth Step: For the first objective lens L1, a first rotational mounting direction is determined based on the generation direction of the first coma aberration.

The first rotational mounting direction is determined from among multiple rotational mounting directions previously associated with the generation directions of coma aberrations. The first rotational mounting direction is obtained by equally dividing the first bearing surface 21 into, for example, twelve sections with lines including a reference line E on the first bearing surface 21 and passing through the center of the first bearing surface 21, and is associated with the generation direction of coma aberration as shown in FIG. 6.

Specifically, based on the generation directions of coma aberration by the correspondence table shown in FIG. 6, the rotational mounting direction (the first rotational mounting direction) is determined to be 5 o'clock direction for the first objective lens L1 in which the generation direction of coma aberration is 300 degrees.

Fifth Step: Similarly, for the second objective lens L2, a second rotational mounting direction is determined based on the generation direction of the second coma aberration. The second rotational mounting direction is obtained by equally dividing the second bearing surface 22 into, for example, twelve sections with lines including a reference line E on the second bearing surface 22 and passing through the center of the second bearing surface 22, and is associated with the generation direction of coma aberration as shown in FIG. 6.

Specifically, based on the generation directions of coma aberration by the correspondence table shown in FIG. 6, the rotational mounting direction (the second rotational mounting direction) is determined to be 12 o'clock direction for the second objective lens L2 in which the generation direction of coma aberration is 100 degrees.

Sixth Step: The first objective lens L1 is mounted on the first bearing surface 21 of the lens holder 20. In this event, the first objective lens L1 is rotated as needed so that the reference point of the first objective lens L1 is positioned in the first rotational mounting direction. To be more specific, an image of the first objective lens L1 mounted on the lens holder 20 is taken with a CCD (Charge Coupled Devices) camera, for example, and the lens is rotated so that the gate G may become desired position by recognizing the twelve rotational mounting directions with identification marks on a monitor. Alternatively, recognition marks such as grooves corresponding to the twelve rotational mounting directions are provided on the lens holder 20, and the lens (position of the gate G) is rotated using these marks as guides.

In the plan view of FIG. 5, as an example, the first objective lens L1 is rotated so that the gate G is positioned in the 5 o'clock direction and is fixed to the first bearing surface 21 with an adhesive. The center C1 of the first objective lens L1 is located on the reference line E of the lens holder 20 along the radial direction.

Seventh Step: Similarly, the second objective lens L2 is mounted on the second bearing surface 22 of the lens holder 20. In this event, the second objective lens L2 is rotated as needed so that the reference point of the second objective lens L2 is positioned in the second rotational mounting direction. To be more specific, an image of the second objective lens L2 mounted on the lens holder 20 is taken with a CCD camera, for example, and the lens is rotated so that the gate G may become desired position by recognizing the twelve rotational mounting directions with identification marks on a monitor. Alternatively, recognition marks such as grooves provided corresponding to the twelve rotational mounting directions are provided on the lens holder 20, and the lens (position of the gate G) is rotated using these marks as guides.

In the plan view of FIG. 5, as an example, the second objective lens L2 is rotated so that the gate G is positioned in the 12 o'clock direction and is fixed to the second bearing surface 22 with an adhesive. The center C2 of the second objective lens L2 is located on the reference line E of the lens holder 20 along the radial direction.

Thus, the generation direction of the first coma aberration by the first objective lens L1 and the generation direction of the second coma aberration by the second objective lens L2 are both aligned in the 3 o'clock direction, i.e., in the radial direction of the optical disc in the plan view of FIG. 5.

Moreover, in this embodiment, as shown in FIG. 4, the first bearing surface 21 is tilted at the first angle α and the second bearing surface 22 is tilted at the second angle β. Accordingly, the first objective lens L1 can be tilted at the first angle α to a plane perpendicular to the optical axis LZ1 of the first laser beam just by mounting the first objective lens L1 on the first bearing surface in the sixth step. Furthermore, the second objective lens L2 can be tilted at the second angle β to a plane perpendicular to the optical axis LZ2 of the second laser beam just by mounting the second objective lens L2 on the second bearing surface 22 in the seventh step.

After determining the first rotational mounting direction (e.g., 5 o'clock direction) by extracting one first objective lens L1 from the first resin mold lot, another first objective lens L1 extracted from the same first resin mold lot is mounted and fixed to the first bearing surface 21 without checking the generation direction of the first coma aberration, so that the gate is positioned in the first rotational mounting direction (5 o'clock direction).

Similarly, after determining the second rotational mounting direction (e.g., 12 o'clock direction) by extracting one second objective lens L2 from the second resin mold lot, another second objective lens L2 extracted from the same second resin mold lot is mounted and fixed to the second bearing surface 22 without checking the generation direction of the second coma aberration, so that the gate is positioned in the second rotational mounting direction (12 o'clock direction).

When the first and second resin mold lots are changed, generation directions of coma aberration are checked in the second and third steps and then first and second rotational mounting directions are determined as in the fourth and fifth steps for the first and second objective lenses L1 and L2 first extracted from the respective lots. Thereafter, if the objective lenses are of the same resin mold lot, both the objective lenses are rotated and disposed in the determined first and second rotational mounting directions without checking the generation directions of coma aberrations.

Thus, an operation of checking and adjusting the direction of coma aberration in mounting of the first and second objective lenses L1 and L2 on the lens holder 20 is no longer required, thereby enabling significant reduction in variation in assembly or in man-hours.

Furthermore, angle adjustment of the first and second objective lenses L1 and L2 and the operation of checking and adjusting a relative shift in tilt between both the lenses using the autocollimator are no longer required.

Note that the same applies to the case where the first and second objective lenses L1 and L2 are mounted on the lens holder 20 of the third embodiment shown in FIG. 9.

In the case of the third embodiment, however, the second bearing surface 22 is tilted at the second angle β from the direction perpendicular to the optical axis LZ2 of the second laser beam by tilting the lens holder 20 or the actuator 30 after the first and second objective lenses L1 and L2 are mounted by the above method (FIG. 9B). The tilt direction is, for example, the extending direction of the reference line E.

Additionally, in this embodiment, the description has been given of the case where the reference line E of the lens holder 20 is provided so that the straight lines passing through the center C1 of the first bearing surface 21 and the center C2 of the second bearing surface 22 coincide with the radial direction of the optical disc D. However, the reference line E may be provided in a tangential direction (TAN direction).

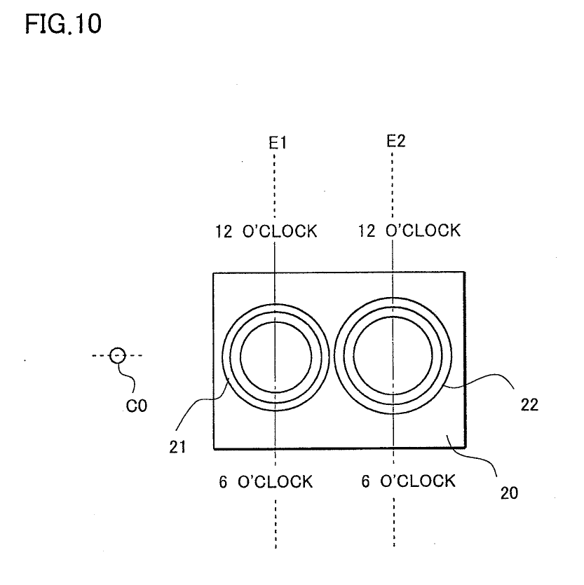

With reference to FIG. 10, a fourth embodiment is described. A first reference line E1 of a first bearing surface 21 and a second reference line E2 of a second bearing surface 22 extend in a tangential direction (6 o'clock to 12 o'clock direction) of an optical disc. For tilt directions of the first and second bearing surfaces 21 and 22, these surfaces are tilted at first and second angles α and β, respectively, so that one side is positioned low and the other side is positioned high, e.g., the 6 o'clock direction is at the lowest and the 12 o'clock direction is at the highest, in the cross sections taken along the first and second reference lines E1 and E2.

The first and second objective lenses L1 and L2 are fixed to the first and second bearing surfaces 21 and 22, respectively, by rotating the lenses (position of the gates G) so that the directions of coma aberration are aligned with the tilt directions (the extending directions of the first and second reference lines E1 and E2).

The extending directions of the first and second reference lines E1 and E2 (the tilt directions of the first and second bearing surfaces 21 and 22) can be set to any directions such as 30-degree direction or 45-degree direction from the radial direction of the optical disc.

Additionally, in this embodiment, the first and second objective lenses L1 and L2 are arranged and fixed on the lens holder 20 so that the straight lines passing through the centers thereof coincide with the radial direction of the optical disc. However, the present invention is not limited thereto.

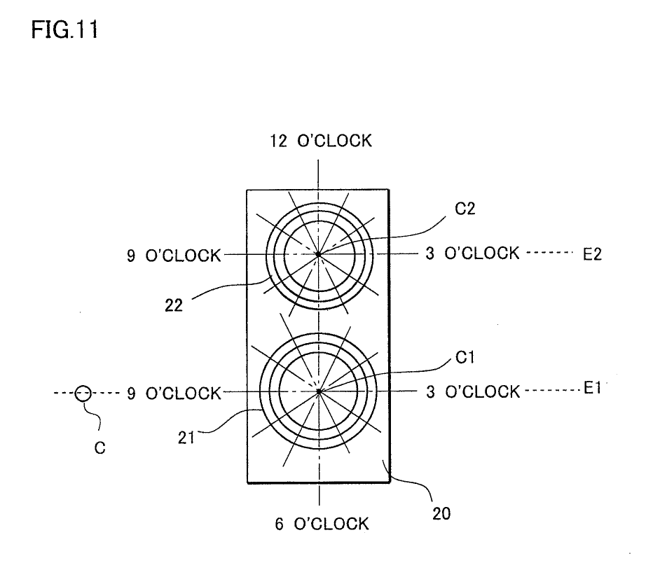

With reference to FIG. 11, a fifth embodiment is described. For example, a first objective lens L1 and a second objective lens L2 may be arranged so that straight lines passing through the centers thereof coincide with a tangential direction of an optical disc. In this case, a first reference line E1 of a first bearing surface 21 and a second reference line E2 of a second bearing surface 22 extend parallel to each other, for example, along (in line with or parallel to) a radial direction of the optical disc.

A tilt direction of the first bearing surface 21 is set to be a tilt direction in the cross sections taken along the first reference line E1 (e.g., the center C0 side of the optical disc is at the highest and the outer circumference side thereof is at the lowest), while a tilt direction of the second bearing surface 22 is set to be a tilt direction in the cross sections taken along the second reference line E2 (e.g., the center C0 side of the optical disc is at the highest and the outer circumference side thereof is at the lowest). The lenses (position of the gates G) are rotated so that the generation directions of coma aberration are aligned with the first and second reference lines E1 and E2 (e.g., 3 o'clock direction for both, i.e., direction along the radial direction of the optical disc). Here, the description has been given of the case where the first reference line E1 of the first objective lens L1 coincides with the radial direction (i.e., on the straight line extending in the radial direction from the center C of the optical disc). Instead, the second reference line E2 of the second objective lens L2 may coincide with the radial direction, or both the lines may be disposed parallel to each other along the radial direction without any of the reference lines coinciding with the radial direction.

The directions of the first and second reference lines E1 and E2 are set to be those along the radial direction, thereby allowing the generation directions of coma aberration to be aligned with the directions along the radial direction.

In this embodiment, when each of the first and second objective lenses L1 and L2 is mounted, rotation directions of both the objective lenses L1 and L2 are determined by a simple method so that the generation directions of coma aberrations by all the first and second objective lenses L1 and L2 are aligned in the same direction as a whole. In other words, the rotation directions of both the objective lenses L1 and L2 are broadly divided into twelve directions, and the lenses of the same resin mold lot are rotated and mounted in a fixing direction so that the directions of coma aberration are aligned in the same direction by selecting any one of the twelve directions.

Furthermore, the use of the lens holder 20, having a structure in which at least one of the objective lenses is mounted at a predetermined angle to the main surface (top surface or bottom surface) of the lens holder 20, allows the objective lenses to be mounted at predetermined angles on mounting portions (bearing surfaces).

Therefore, while the two-wavelength laser diode which emits laser beams of two different wavelengths is used as the configuration of the second optical system in the embodiment, a laser diode which emits a laser beam of a single wavelength can also be used.

Moreover, while the description has been given of the first objective lens L1 for BD standard in the embodiment, the present invention is also applicable to an objective lens for HD-DVD standard.

Additionally, in this embodiment, the description has been given of the optical pickup device using two BD/DVD/CD-compatible objective lenses, as an example. However, the present invention is also applicable to an optical pickup device compatible with other standards using two or more objective lenses.

For example, when three objective lenses are used, a bearing surface for a third objective lens is tilted at a desired angle as in the case of the first and second objective lenses L1 and L2, and the third objective lens is rotated and mounted by providing multiple rotational mounting directions, thereby achieving the same effects as those described above.

The present invention enables simple and easy adjustment of coma aberration by broadly dividing the rotational direction for correcting the coma aberration. Also, the present invention enables the angles of the two objective lenses to be easily adjusted for correcting the coma aberration by employing the configuration in which at least one of the two bearing surfaces of the lens holder is tilted in advance, and in which the two objective lenses are tilted at such angles that the relative amount of coma can be reduced. The present invention thus enables the simple and easy adjustment of coma aberration, and eliminates the necessity of cumbersome and complicated work for coma aberration correction and a variation in adjustment.

The embodiments of the present invention can achieve the following effects. First, by tilting the bearing surface of the lens holder at a predetermined angle to the optical axis of the laser beam, adjustments for individual optical pickup devices and for correction of coma aberration in individual objective lenses can be significantly reduced. This makes it possible to reduce a variation in adjustment and man-hours and thus to realize an inexpensive BD/DVD/CD-compatible optical pickup device having performance associated with no practical problem.

To be more specific, the first bearing surface on which the first objective lens is mounted and the second bearing surface on which the second objective lens is mounted are tilted at angles at which the coma aberration can be absorbed, and then the lenses are mounted and fixed onto the respective bearing surfaces so that the generation directions of coma aberration by the first and second objective lenses are aligned with each other. For the first and second objective lenses, the generation directions of the coma aberration are aligned with tilt directions. By allowing the tilt directions to coincide with the radial direction of the optical disc, for example, the directions of the coma aberration can be aligned with the radial direction of the optical disc. This eliminates cumbersome and complicated adjustment for correcting the coma aberration for the first and second objective lenses.

For the objective lens for BD, the tilt is set to be an angle (0.25 degree) that is one-half of an angle (approximately 0.5 degree) corresponding to the maximum amount of coma aberration generated by the objective lens for BD. For the objective lens for DVD, the tilt is set to be an angle (0.15 degree) that is one-half of an angle (approximately 0.3 degree) corresponding to the maximum amount of coma aberration generated by the objective lens for DVD. Accordingly, the coma generation variation described above can be corrected just by mounting the two objective lenses without making any adjustment on the lens holder, thereby achieving the same effect as the significant reduction in the amount of coma aberration generated by the objective lenses.

Moreover, the relative amount of coma can be reduced since the generation directions of coma aberration by the first and second objective lenses are aligned in approximately the same direction. To be more specific, the generation direction of coma aberration is aligned in the radial direction of the optical disc. Thereby, the relative amount of coma in the two objective lens can be reduced to 0λ in the tangential direction of the optical disc (direction perpendicular to the radial direction) and to ±0.04λ in the radial direction of the optical disc.

As a method for mounting the first and second objective lenses described above so that the generation directions of coma aberration are aligned, with attention paid to the characteristics of resin-made objective lenses in which amounts or directions of coma aberration correspond between resin mold lots, directions of coma aberration in the respective objective lenses are broadly divided by a simple method and the directions of coma in the two objective lenses are aligned based on the division. To be more specific, the generation direction of coma aberration is recognized by a position of a gate formed in formation of a plastic lens, and an actual generation direction of coma aberration is broadly divided into twelve directions, for example. Then, the position of the gate is rotated in any of the twelve directions, thereby aligning the generation direction of coma aberration with the radial direction of the optical disc.

The objective lenses sorted out in the twelve directions as the same direction may differ in generation direction of coma aberration. If an angular shift is about ±15 degrees, variation in coma aberration due to the angular shift is small, and such a variation is practically negligible.

Thus, even in the case of mounting the two objective lenses for BD and for DVD/CD on one lens holder, not only the mounting positions can be accurately set but also an assembly operation can be efficiently performed.

Furthermore, the same effect as described above can be achieved in such a manner that after fixing the first and second objective lenses by rotating the position of the gate in any of the twelve rotational mounting directions, for example, which are set in the lens holder by the above method, the lens holder or the actuator is tilted at a predetermined angle, thereby tilting the first objective lens at a first angle and the second objective lens at a second angle.

What is claimed is:

1. An optical pickup device comprising:
a first objective lens fixed on a lens holder and configured to receive a first laser beam of a first wavelength and to focus the first laser beam on a signal recording layer provided in an optical disc, the lens holder supported by support wires so that the lens holder is movable toward a signal surface of an optical disc and in a radial direction of the optical disc; and
a second objective lens fixed on the lens holder and configured to receive a second laser beam of a second wavelength different in wavelength from the first laser beam and to focus the second laser beam on a signal recording layer provided in an optical disc, wherein
the lens holder is provided with a first bearing surface and a second bearing surface, and at least one of the first and second bearing surfaces is tilted to a main surface of the lens holder,
the first objective lens has a first coma aberration, is fixed on the first bearing surface, and is tilted at a first angle to an optical axis of the first laser beam, and
the second objective lens has a second coma aberration, is fixed on the second bearing surface so that a direction of the first coma aberration is aligned with a direction of the second coma aberration, and is tilted at a second angle to an optical axis of the second laser beam.

2. The optical pickup device according to claim 1, wherein
the lens holder has a plurality of rotational mounting directions set on each of the first bearing surface and the second bearing surface by equally dividing the bearing surface with lines passing through the center of the bearing surface,
the first objective lens is fixed onto the first bearing surface so that a reference point of the first objective lens is positioned in a first rotational mounting direction corresponding to the generation direction of the first coma aberration, and
the second objective lens is fixed onto the second bearing surface so that a reference point of the second objective lens is positioned in a second rotational mounting direction corresponding to the generation direction of the second coma aberration.

3. The optical pickup device according to claim 2, wherein the rotational mounting directions are at least four directions.

4. The optical pickup device according to claim 3, wherein the generation direction of the first coma aberration and the generation direction of the second coma aberration are recognized by angles with respect to the reference points of the first and second objective lenses, respectively.

5. The optical pickup device according to any one of claims 1 and 2, wherein the generation direction of the first coma aberration and the generation direction of the second coma aberration are aligned with the radial direction of the optical disc.

6. The optical pickup device according to claim 5, wherein the first bearing surface is tilted.

7. The optical pickup device according to claim 5, wherein the first bearing surface is provided horizontal to the main surface of the lens holder, and the lens holder is tilted.

8. The optical pickup device according to claim 5, wherein the second bearing surface is tilted.

9. The optical pickup device according to claim 5, wherein the second bearing surface is provided horizontal to the main surface of the lens holder, and the lens holder is tilted.

10. The optical pickup device according to any one of claim 4, wherein the first and second objective lenses are both resin-made lenses.

11. An optical pickup device comprising:
a first objective lens configured to receive a first laser beam of a first wavelength and to focus the first laser beam on a signal recording layer provided in an optical disc, the first objective lens being fixed on a lens holder supported by support wires so that the lens holder is movable toward the signal surface of the optical disc and in a radial direction of the optical disc; and
a second objective lens fixed on the lens holder and configured to receive a second laser beam of a second wavelength different in wavelength from the first laser beam and to focus the second laser beam on a signal recording layer provided in an optical disc, wherein
the lens holder has a first bearing surface on which a first objective lens is mounted and a second bearing surface on which a second objective lens is mounted,
each of the first and second bearing surfaces has multiple rotational mounting directions set thereon, by equally dividing the bearing surface with lines passing through the center of the bearing surface,
the first objective lens is fixed onto the first bearing surface so that a reference point of the first objective lens is positioned in one of the rotational mounting directions, corresponding to a direction of a first coma aberration generated by the first objective lens, and is tilted in the generation direction of the first coma aberration, and
the second objective lens is fixed onto the second bearing surface so that a reference point of the second objective lens is positioned in one of the rotational mounting directions, corresponding to a direction of a second coma aberration generated by the second objective lens, and is tilted in the generation direction of the second coma aberration.

12. The optical pickup device according to claim 11, wherein the lens holder has identification marks corresponding to the rotational mounting directions.

13. The optical pickup device according to claim 12, wherein the first bearing surface is provided horizontal to a main surface of the lens holder.

14. The optical pickup device according to claim 12, wherein the second bearing surface is provided horizontal to a main surface of the lens holder.

15. A method for manufacturing an optical pickup device including: a first objective lens configured to receive a first laser beam of a first wavelength and to focus the first laser beam on a signal recording layer provided in an optical disc, the first objective lens being fixed on a lens holder supported by support wires so that the lens holder is movable toward the signal surface of the optical disc and in a radial direction of the optical disc; and a second objective lens fixed on the lens holder and configured to receive a second laser beam of a second wavelength different in wavelength from the first laser beam and to focus the second laser beam on a signal recording layer provided in an optical disc, the method comprising the steps of:
preparing one first objective lens extracted from a first resin mold lot and one second objective lens extracted from a second resin mold lot;
checking a direction of a first coma aberration generated by the first objective lens;
checking a direction of a second coma aberration generated by the second objective lens;
determining a first rotational mounting direction corresponding to the generation direction of the first coma aberration from among a plurality of rotational mounting directions previously associated with generation directions of coma aberration;
determining a second rotational mounting direction corresponding to the generation direction of the second coma aberration from among the plurality of rotational mounting directions;
mounting the first objective lens on the first bearing surface so that a reference point of the first objective lens is positioned in the first rotational mounting direction; and
mounting the second objective lens on the second bearing surface so that a reference point of the second objective lens is positioned in the second rotational mounting direction.

16. The method for manufacturing an optical pickup device, according to claim 15, wherein
the first objective lens is tilted at a first angle with respect to an optical axis of the first laser beam, and the second objective lens is tilted at a second angle with respect to an optical axis of the second laser beam.

17. The method for manufacturing an optical pickup device, according to claim 16, wherein
the first rotational mounting direction of another first objective lens extracted from the first resin mold lot is determined without the generation direction of the first coma aberration checked individually for the another first objective lens, and
the second rotational mounting direction of another second objective lens extracted from the second resin mold lot is determined without the generation direction of the second coma aberration checked individually for the another second objective lens.

18. The method for manufacturing an optical pickup device, according to claim 17, wherein the reference point is a position of a gate for injecting resin into a resin mold.

19. The method for manufacturing an optical pickup device, according to claim 15, wherein the generation direction of the first coma aberration and the generation direction of the second coma aberration are aligned with the radial direction.
